(19) United States
(12) Patent Application Publication
(10) Pub. No.: US 2016/0159300 A1
(43) Pub. Date: Jun. 9, 2016

(54) BEAM INCORPORATING ALUMINUM EXTRUSION AND LONG-FIBER REINFORCED PLASTIC

(71) Applicant: Shape Corp., Grand Haven, MI (US)

(72) Inventors: Joseph R. Matecki, Allendale, MI (US); Brian E. Malkowski, Allendale, MI (US)

(21) Appl. No.: 14/956,489

(22) Filed: Dec. 2, 2015

Related U.S. Application Data
(60) Provisional application No. 62/087,950, filed on Dec. 5, 2014.

(51) Int. Cl. B60R 19/18; B23P 15/00; B60R 19/03

(52) U.S. Cl. CPC B60R 19/18; B60R 19/03; B23P 15/00; B60R 2019/182; B60R 2019/1853; B23P 2700/50

(57) ABSTRACT

A hybrid impact beam, suitable for use as a reinforced impact beam in vehicle bumpers, includes an extruded aluminum section, a fiber reinforced polymeric (FRP) section, and a structural adhesive bonding them together. The components are arranged so that during an impact, the aluminum section experiences compression and receives the direct impact, the FRP section experiences tension, and the adhesive experiences minimal stress by being on a neutral plane of the beam's bending moment. The extruded aluminum beam is preferably extruded as an open section, but becomes a closed section when the polymeric section is attached. The FRP section is preferably a continuous carbon fiber reinforced polymeric section, although different reinforcements can be used. A related method includes bonding an extruded aluminum and fiber-reinforced polymeric section together to form a closed bumper impact beam.

### CROSS-REFERENCE TO RELATED APPLICATION

This application claims benefit under 35 USC section 119(e) of U.S. Provisional Patent Application Ser. No. 62/087,950 entitled BEAM USING ALUMINUM EXTRUSION AND LONG-FIBER REINFORCED PLASTIC, filed Dec. 5, 2014, the entire contents of which are incorporated herein by reference.

### BACKGROUND OF THE INVENTION

The present invention relates to impact beams where optimal impact properties and low weight are important, and more particularly relates to a hybrid impact beam constructed from a combination of an extruded aluminum section, fiber-reinforced polymeric material, and adhesive, where the materials are optimally located to manage compressive, tensile, and torsional stress during an impact.

Bumper reinforcement beams for vehicle bumper systems have stringent functional requirements. Low weight is important due to its effect on vehicle gas mileage, but strength and impact properties are important given the government (FMVSS) and insurance industry (IIHS) safety standards for bumper systems. One dilemma is that no single material or process satisfies all design goals. For example, aluminum has low weight, but is not as strong as high strength steel, nor as light as polymeric material. Also, aluminum material tends to perform acceptably under compressive stress but not as well under tensile stress. Aluminum extruding processes can eliminate some manufacturing steps, but extruding processes limit the beam shapes that can be produced, and further limit the types and strengths of aluminum materials that can be used. Polymeric material has very low weight, but is not as strong as steel nor aluminum. Also, reinforced polymeric materials tend to provide significantly poorer impact strength than metals, especially when formed into thin walls. Polymeric materials tend to perform acceptably under tensile stress but not as well under compressive stress.

A subtle but significant design problem is that when a beam is “beefed up” in order to meet government and insurance industry standards, other areas will have “excess” material or will provide an “overkill” of strength and function. In some words, more material or strength is provided in some areas than is optimally required to meet the standards, thus leading to unnecessarily high cost or weight where “excess” material is located in unnecessary areas. For example, a center of a bumper reinforcement beam is spaced from the vehicle's bumper mounts such that it sees much higher/different bending requirements than ends of the beam which are located directly over/near the bumper mounts. Also, a front wall (face) of a bumper beam must be designed to receive direct contact during a vehicle impact (such that it undergoes high compressive forces and relatively sharp impact load peaks), while a rear wall receives stresses indirectly passed from the front wall through other walls/components of the beam to the rear wall. As a result, that load peaks may not be as sharp. Thus, bumper beams made of a single material often cannot be optimally designed for particular vehicles' bumper systems in terms of best localized strength properties (which needs vary along a bumper's length), low weight, and maximum value per unit weight and per unit function.

An improvement is desired that provides the advantages of extruded sections (e.g. extruded aluminum sections), and that also takes advantage of most-desired properties of aluminum, while also minimizing the least-desired properties of the aluminum. An improvement is desired that maintains a flexibility of design, yet that optimizes use of materials and their properties, including the properties of metal (aluminum) and plastic (esp. fiber-reinforced polymeric materials), especially at localized regions along a bumper beam. A design is desired that provides savings and improvements in terms of impact strength, functional and dimensional properties, and efficiency of manufacture.

### SUMMARY OF THE INVENTION

In one aspect of the present invention, a bumper impact beam adapted for impact comprises an extruded aluminum section having a constant cross section; a long-fiber-reinforced polymeric elongated section positioned against a rear side of the aluminum section to define at least one closed cavity; and an adhesive integrally securing the elongated section to the aluminum section so that when impacted anywhere along a front side of the beam, the aluminum section is primarily compressed and the polymeric elongated section is primarily tensioned.

In a narrower aspect of the present invention, the aluminum section forms a forward portion of the beam and the polymeric elongated section forms a rearward portion of the beam, with abutting surfaces of the aluminum section and polymeric elongated section lying along a neutral plane, the neutral plane being defined by type of stress during an impact directed against the front side of the beam, with the type of stress being primarily compressive stress in the extruded aluminum section and primarily tensile stress in the polymeric elongated section.

In another aspect of the present invention, a beam adapted for impact, comprises an extruded section including parallel walls defining at least one rear concavity, at least one of the walls including a rearwardly-facing tip; a continuous-fiber-reinforced polymeric elongated section with forwardly-facing walls that abut the parallel walls to close the at least one rear concavity; and at least one fastener securing the polymeric elongated section to the extruded section including at the rearwardly-facing tip.

In another aspect of the present invention, a bumper impact beam adapted for impact comprises an extruded aluminum section with a rearwardly-extending wall having a rear tip defining a longitudinal channel; a long-fiber-reinforced polymeric elongated section including a forwardly-extending wall having a front tip extending into the longitudinal channel and fixed thereto.

In another aspect of the present invention, a bumper impact beam adapted for side impact, comprises an extruded aluminum section including walls defining at least one tubular concavity; and a long-fiber-reinforced polymeric elongated sheet bonded to a rear one of the walls along a center portion thereof.

In a narrower aspect of the aspect noted immediately above, a fastener secures the elongated sheet to the aluminum section, the fastener including one or both of adhesive and mechanical fasteners.

In another aspect of the present invention, a bumper impact beam adapted for impact, comprises a plurality of long-fiber-reinforced polymeric sheets with abutting edges arranged to form a geometric polygon with flat walls and corners and at least one tubular concavity; and extruded aluminum angles securing the abutting edges together at each of the corners.

In another aspect of the present invention, a method of constructing a vehicle bumper beam comprises extruding an aluminum section; forming a long-fiber-reinforced elongated polymeric section; and securing the polymeric section to the aluminum section to form at least one closed cavity; the step of securing including applying and curing adhesive.

In another aspect of the present invention, a method of forming a bumper impact beam adapted for impact, comprises providing an extruded aluminum section including walls defining at least one tubular concavity; and adhering a long-fiber-reinforced polymeric elongated sheet to a rear one of the walls along at least a center portion of the aluminum section.

An object of the present invention is to construct a beam with metal material (e.g. aluminum) in an optimal location to undergo compression during an impact against the beam, and with polymeric material (e.g. long-fiber-reinforced polymeric material) in an optimal location to undergo tension during the impact, and with adhesive and dissimilar bonded materials in an area of low stress during the impact (i.e. along a neutral plane).

An object of the present invention is to construct a beam of extruded aluminum and fiber-reinforced polymeric material, and with mechanical fasteners that hold the aluminum and polymeric material together until an adhesive cures and fully bonds abutting/adjacent materials, the fasteners also providing additional retaining strength during an impact in the fully cured beam.

An object of the present invention is to incorporate mechanical locking and adhesive-enabling features that can be integrally formed when extruding aluminum sections.

An object of the present invention is to extrude aluminum sections that are open sections (i.e. not closed tubes), thus allowing increased manufacturing efficiency when extruding the aluminum sections, yet providing a beam incorporating the aluminum sections that is a closed section so that, when impacted, it provides optimal impact bending strengths, high energy absorbing properties, high strength-to-weight ratios, high energy-absorption-to-weight ratios, and reduced total mass.

These and other aspects, objects, and features of the present invention will be understood and appreciated by those skilled in the art upon studying the following specification, claims, and appended drawings.

### BRIEF DESCRIPTION OF THE DRAWINGS

FIGS. 1, 1A, 2-9, 9A, and 10 are views of various embodiments of vehicle bumper reinforcement beams embodying the present inventive concepts, each being made from an extruded aluminum section and a long-fiber-reinforced polymeric section, bonded together such as by a structural adhesive, the individual sections being open sections or basic planar shapes, but when combined defining one or two closed sections, FIG. 1A showing a beam from FIG. 1 attached to vehicle frame rails.

FIG. 11 is a force-deflection curve comparing a baseline beam to the beam of FIG. 10.

FIG. 12 is a perspective view of another modified beam similar to the aluminum beam in FIG. 9A, but including a short carbon fiber reinforcement patch (CFRP) adhered to its center rear surface.

FIG. 13 is a perspective view of another modified beam, similar to the beam in FIG. 12 but with mechanical fasteners holding corners of the CFRP sheet to the beam.

### DETAILED DESCRIPTION OF PREFERRED EMBODIMENTS

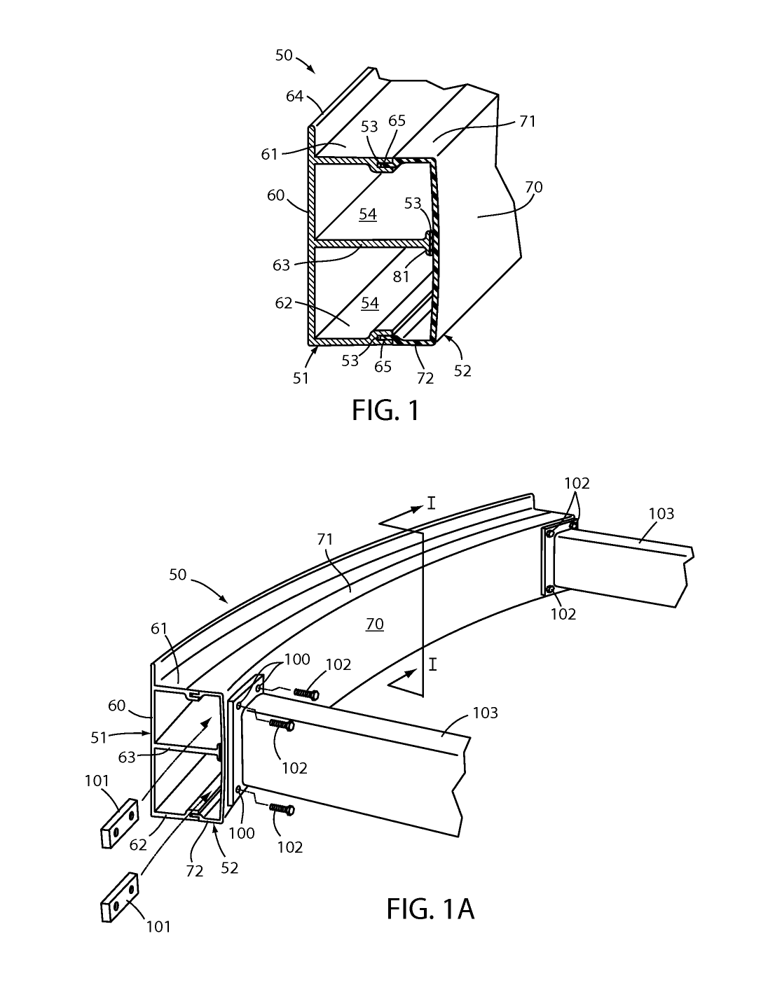

The present innovative system comprises an impact beam, such as can be used as a bumper reinforcement beam in vehicle bumper systems. The illustrated beam 50 of FIG. 1 bonds a multi-channel-shaped fiber reinforced polymeric (FRP) part 52 to an extruded metal section 51 (e.g. aluminum) using structural adhesive 53, to thus form an impact beam suitable for attachment to vehicle frame rails 104 as a bumper reinforcement beam. The illustrated arrangement includes attachment plate brackets 101 placed inside the beam 50, and fasteners 102 extended through holes 103 in a plate at a front end of the illustrated frame rail tips 104 and extended into threaded holes in the brackets 101. However, it is contemplated that various attachment constructions can be used and are within a scope of the present invention.

The present innovation focuses/facilitates optimizing beams during design while maintaining flexibility of design, with the beam having optimal properties of: high impact strength at peak load, high energy absorption and acceptable energy absorption profile during an impact stroke, high impact strength per unit weight, and low total weight, while optimally meeting localized functional and strength requirements along the beam without providing “excess” material in localized areas where it is not required, and while also providing excellent and cost-effective manufacturability. In preferred embodiments, the extruded section is a high strength aluminum, which provides excellent compressive strength and excellent impact properties upon receiving a “sharp” direct impact, and which contributes to an excellent strength to weight ratio.

In a preferred embodiment, the aluminum section is an open section, such as shown in FIGS. 1 and 1A. The fiber reinforced polymeric (FRP) material is preferably a continuous-fiber-reinforced polymeric material, where the reinforcement fibers extend continuously from end to end of the polymeric material component, such as provided in a pultruded or extruded polymeric component. More preferably, the FRP material is a continuous carbon fiber reinforced polymeric (CFRP) material, with the carbon fibers arranged in an optimal pattern, such as woven mat or fabric, fiber bundles, and where fibers have various orientations and strand arrangements for optimal reinforcement properties. However, it is contemplated that a scope of the present innovation includes a continuous or long glass fiber reinforced polymeric material as well, such as where the long fibers are greater than about 1 inch but less than a full length of the component.

Extruded aluminum sections incorporated into the present innovation can have many different shapes. A part of the present innovation is based on the fact that simple non-tubular extruded shapes (sometimes referred to as “open sections” or “solid profile” or “semi-hollow” profiles) can be made from classes of extrudable aluminum having a higher tensile strength than those classes of aluminum required for tubular extruded shapes. For example, the present extruded aluminum section in FIG. 1 can be made from aluminum having a tensile strength of about 500 MPa (or more), while known closed extruded aluminum sections for bumper beams typically use aluminum having a tensile strength of less than 450 MPa, (such as those generally closer to 300 MPa). Also, a part of the present innovation is based on the fact that open sections of extruded aluminum can be extruded at much higher manufacturing rates (e.g. 10%-20% higher manufacturing speeds) than speeds for closed extruded sections. This allows the present innovation to provide stronger and lighter-weight beams at higher production rates.

Metal and FRP materials have different properties, and the present innovation is based in part on the fact that it is desirable to construct a beam optimally using these materials for localized optimal properties. In particular, extruded aluminum materials can provide good/high compressive strength and are resistant to catastrophic immediate collapse upon sharp impact loading, but they tend to have less acceptable tensile properties. Contrastingly, carbon (or other fibers such as Kevlar, etc.) fiber reinforced polymeric (CFRP) materials (also called “carbon fiber composites” herein) can provide good/high tensile strengths, but tends to have less acceptable compressive strengths, especially at high stress locations. Also, structural adhesives can provide good/high retention strength, but are susceptible to failure when unacceptably compressed or tensioned. The present innovation places extruded aluminum sections in forward locations of the beam where a front impact results primarily in compressive stresses and sharp loading, and places FRP materials in rear locations of the beam where a front impact results primarily in tensile stresses, and places adhesive close to “boundaries” of neutral stress during an impact against a side of the beam.

It is noted that the present innovation can incorporate many different types of adhesives, and that are generally well known and commercially available. The type of adhesive selected is based on functional and process requirements of the hybrid beam being constructed. However, it is noted that the structural adhesive used in the present prototype parts was a Methacrylate Adhesive, which is a two part curing adhesive. All testing was done after the adhesive was fully cured.

In the following descriptions, different embodiments use identical numbers to label identical or similar features, characteristics, aspects, and attributes, but also include a letter (e.g. “A”, “B”, “C”, etc). This is done to reduce and/or eliminate redundant discussion. Thus, a description of a first embodiment applies to and also describes later embodiments, and vice versa.

The vehicle bumper reinforcement beam 50 (FIG. 1) includes an extruded aluminum section 51, a carbon-fiber-reinforced polymeric (CFRP) section 52, and adhesive 53 bonding the sections 51 and 52 together at abutting locations to define closed cavities 54. The illustrated extruded aluminum section 51 has an “E” shaped cross section, and includes a vertical front wall 60, rearwardly-extending top wall 61, rearwardly-extending bottom wall 62, rearwardly-extending middle wall 63, and an up flange 64 (e.g. used to support a vehicle front fascia above the beam). The top and bottom walls 61, 62 each include a rear tip defining a longitudinal channel 65. The middle wall 63 defines a transverse foot or flange that abuts the rear wall 70 discussed below. It is contemplated that the beam 50 can be attached to vehicle frame rails by different means, one such way being by a metal plate bracket that slips into the beam for threadably receiving attachment bolts fastening the beam 50 to a vehicle's frame rails as described above (FIG. 1A).

The walls 60-63 define a section having two rearwardly-facing open channels. The CFRP section 52 is C-shaped, and includes a vertical rear wall 70, a top wall 71, and a bottom wall 72. A tip of the polymeric top wall 71 extends into the channel 65 of the extrusion's top wall 61. It is contemplated that it can simply fit matably into the channel 65; or be configured to snap into an interlocked position; or be configured to rotate/tip into an interlocked position to generate self-holding friction. A two-part structural adhesive 53 in the channel 65 fills an area around the abutting material and, when cured, secured the sections 51 and 52 together. The preferred adhesive 53 is two part and cures over time and with heat. A tip of the polymeric bottom wall 72 also extends into a channel in the extrusion's bottom wall 62 and is similarly secured. A tip of the extrusion's middle wall 63 has a transverse flange 81 (also called a foot herein) that abuts the inner surface of the polymeric section 52 along its centerline. Adhesive 53 is squeezed between the transverse flange 81 and the polymeric section 52 during assembly so that, when cured, it provides good holding power. During an impact, impact forces are transmitted directly through the interface into the middle wall 63 with minimal shear, such that the abutting contact along with adhesive 53 is believed to be sufficient. It is noted that the extrusion process allows the walls 60-63 of the extruded aluminum section 51 to have different thicknesses. Thus, for example, the middle wall 63 may be made thinner, since its stresses during an impact are relatively linear and parallel to a length of the middle wall 63. Also, the middle wall 63 does not contribute as much to torsional stability of the beam 50. Contrastingly, the top and bottom walls 61 and 62, and also the front wall 60, may undergo different impact forces (e.g. bending and/or torsional and/or shearing forces), and further they must provide torsional strength to pass government (FMVSS) and insurance (IIHS) industry test standards, such that these walls will typically be thicker.

It is noted that in beam 50, the extruded aluminum section 51 is positioned on a front of the beam 50 so that, when impacted anywhere along a front half of the beam, the aluminum section 51 is primarily compressed due to bending forces on the beam. Contrastingly, the polymeric elongated section 52 is positioned so that when impacted, the polymeric elongated section 52 is primarily tensioned. Contrastingly, the adhesive 53 at the top, middle, and bottom interface joints is located along a vertical longitudinal plane of neutral stress, where stress is minimized between tension and compression.

The beam 50 can be any size required for a particular application, and can be longitudinally swept or made curvilinear to match a shape and aesthetics of a vehicle front end. For example, the illustrated beam's cross sectional size is about 120 mm high by 40 mm wide. As noted above, wall thickness depends on selection of materials and functional requirements of a particular application. In illustrated beam 50 (FIG. 1), all walls of the aluminum and polymeric components are about the same. However, it is noted that the polymeric walls may be slightly increased in thickness over the aluminum walls, and/or the intermediate middle wall 54 of the aluminum extrusion might be thinner than other walls in the aluminum extrusion.

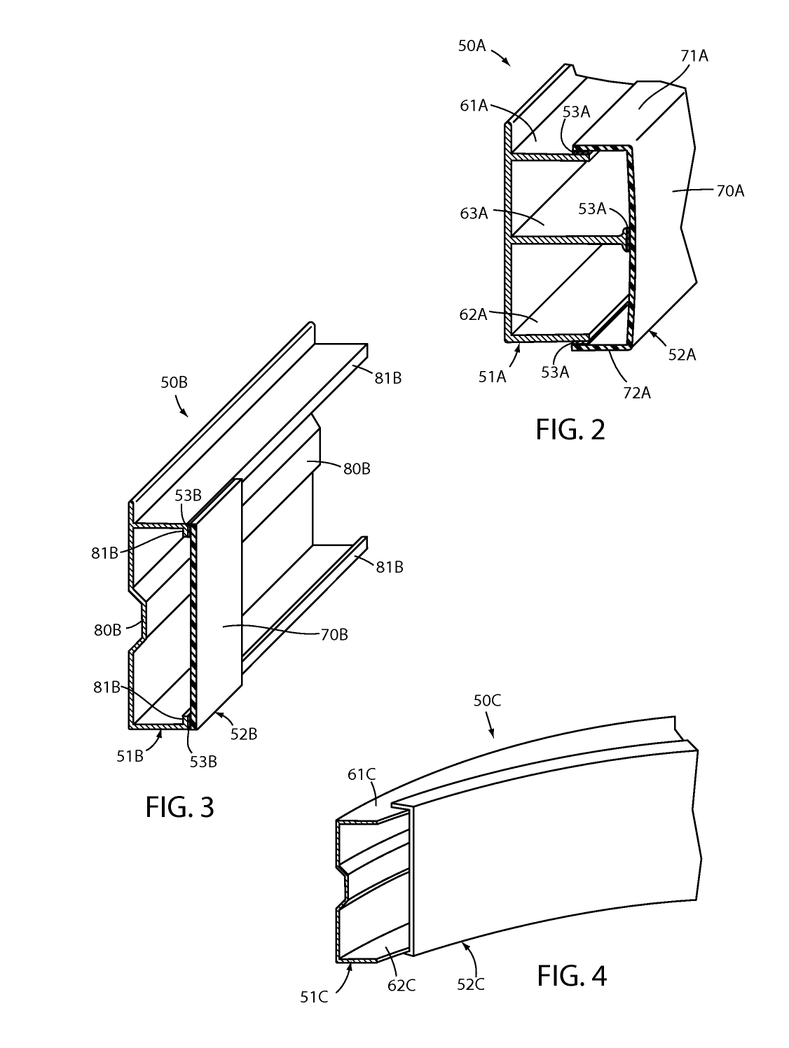

Beam 50A (FIG. 2) is similar to beam 50, but beam 50A does not include tip channels (65). Instead, the adhesive 53A bonds overlapping edge flanges of the extrusion's top wall 61A and polymeric section's top wall 71A, and bonds overlapping edge flanges of the extrusion's bottom wall 62A and polymeric section's bottom wall 72A. Notably, by the extruded aluminum top wall 61A being on an inside, the CFRP's top wall 71A can be pressed against the extruded aluminum top wall 61A as the adhesive 53A cures.

Beam 50B (FIG. 3) is similar to beam 50, but beam 50B does not include a middle wall (63) on the top and bottom walls. Instead, the front wall 61A includes a shallow channel rib 80B formed centrally thereon for stiffening the front wall. Also, the top and bottom walls 61B and 62B include transverse flanges 81B on their tips, the transverse flanges 81B being configured to abuttingly engage mating top and bottom edges of the rear wall 70B of the polymeric section 52B. Adhesive 53B secures the abutting surfaces of the transverse flanges 81B to the abutting CFRP section. Notably, wall 70B can be as long or short as desired.

Beam 50C (FIG. 4) is similar to beam 50B including a channel in its front wall, but beam 50C includes is non-linear and instead includes a longitudinal curve (also called a “sweep”). Specifically, both the front section 51C and rear section 52C are swept. Further, a length of the top and bottom walls 61C and 62C vary along a length of the beam 50C, with ends being shorter than near a center. Also, the top and bottom walls 61C and 62C extend sufficiently to contact the rear wall of the section 52C at the corners. By this arrangement, a center of the beam has a greater cross sectional size (in a fore-aft direction when in a vehicle-mounted position) than ends of the beam 50C. Thus, a center of the beam 50C defines a larger tubular shape than ends of the beam, thus providing greater torsional and bending strength along a center of the beam. This can be important because the center is spaced from the end-located mounts for mounting the beam to a vehicle frame, such that the center of the beam requires more torsional and bending strength than ends of the beam (which ends are immediately over the bumper mount locations).

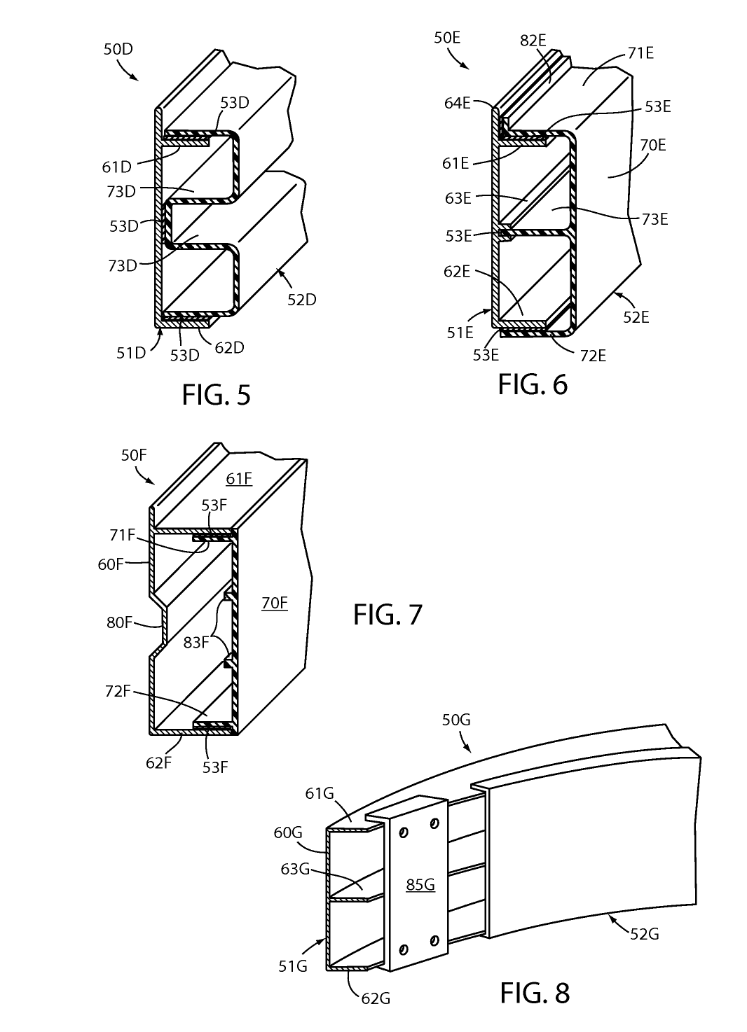

Beam 50D (FIG. 5) is similar to beam 50 in that beam 50D defines a closed section with two cavities, but in beam 50D, the extruded aluminum section 51D is relatively planar with short walls 61D-62D, and the CFRP section 52D has a W-shaped cross section including two middle walls 73D joined with a connecting wall. The top and bottom walls of each section 51D and 52D are bonded together using adhesive 53D. Also, adhesive 53D is located between the connecting wall of the CFRP section 52D and the abutting material of the extruded aluminum section 51D.

Beam 50E (FIG. 6) is similar to beam 50, except in beam 50E, the extruded aluminum top wall 61E and CFRP top wall 71E overlap, with the CFRP top wall 71E also including a transverse flange 82E abutting the rear surface of the up flange 64E. The bottom walls 62E and 72E also overlap and are bonded by adhesive 53E. The middle wall 73E extends between two short middle walls 63E, where it is bonded by adhesive 53E.

Beam 50F (FIG. 7) is similar to beam 50, except in beam 50F, the front wall 60F includes a stiffening channel rib 80F. Also, Beam 50F does not include a CFRP middle wall, but instead there are two short stiffening ribs 83F on a front surface of the rear wall 70F. The top walls 61F and 71F overlap and are bonded with adhesive 53F, and the bottom walls 62F and 72F overlap and are bonded with adhesive 53F.

Beam 50G (FIG. 8) is similar to beam 50C (FIG. 4). However, in beam 50G, the extruded aluminum section 51G has a middle wall 63G (and does not have a shallow stiffening rib in the front wall 60G). Also, the CFRP section 52G ends short of the end of the aluminum section 51G. A mounting bracket 85G is attached to a rear of the aluminum section 51G for mounting the beam to a vehicle frame. The mounting bracket 85G can be metal or plastic or other material. The illustrated bracket 85G includes holes facilitating attachment of the beam 50G by threaded fasteners (not shown) to the vehicle frame.

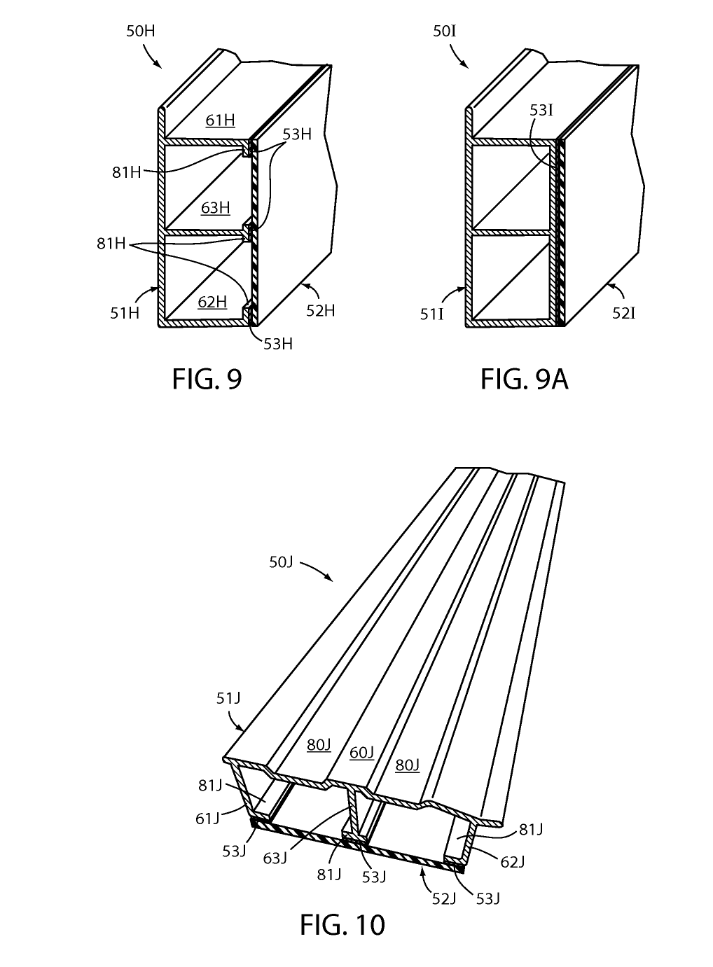

Beam 50H (FIG. 9) is similar to beam 50, except in beam 50H, the extruded aluminum section 51H includes top, bottom, and middle walls 61H-63H each with transverse flanges 81H that abut a planar sheet of the CFRP section 52H, with adhesive securing the CFRP section 52H to the flanges 81H. Beam 50I (FIG. 9A) is similar to beam 50H, except a continuous rear (aluminum) wall replaces the transverse flanges shown in FIG. 9. Adhesive 53I bonds to rear wall of the aluminum section 51I to the CFRP section 52I.

Beam 50J (FIG. 10) is similar to beam 50 except in beam 50J, the extruded aluminum section 51J has a front wall 60J with two shallow stiffening channel ribs 80J, each channel rib 80J being over a concavity of the closed section beam 50J. Also, the top, bottom and middle walls 61J-63J each have a transverse flange 81J abutting and adhered to the CFRP section 52J with adhesive 53J.

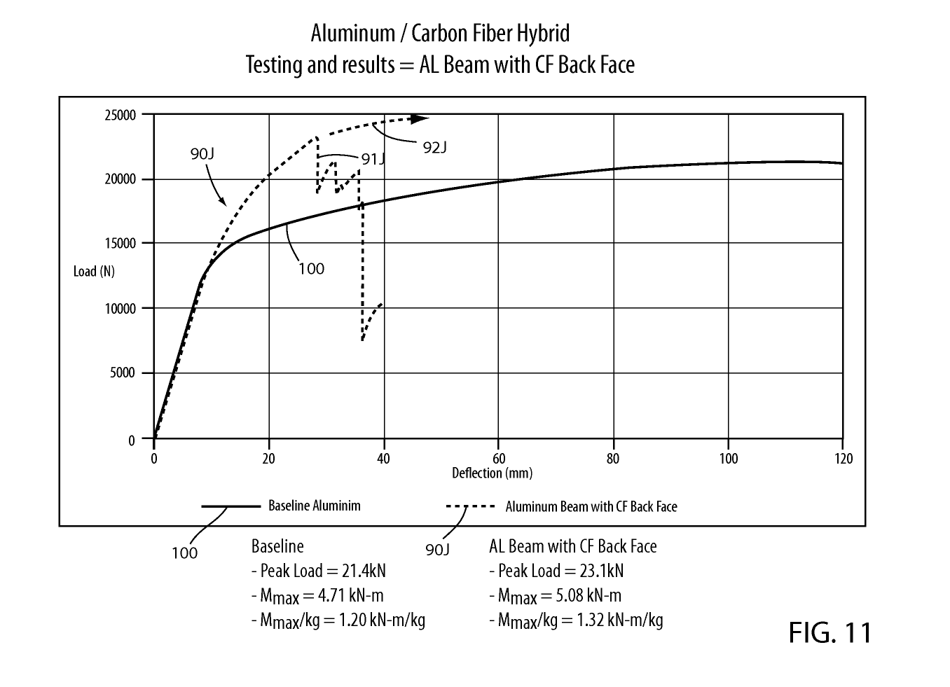

FIG. 11 is a graph comparing a force-deflection (f-d) curve 90J resulting from a centered bending impact against a side of a beam 50J (FIG. 10), and comparing it against a force-deflection curve 100 resulting from similar impact against a baseline beam (closed extruded aluminum defining double tubes, similarly sized cross section, but no added component and no carbon fiber reinforced polymeric “CFRP” section). The f-d curve 90J of the beam 50J tracks the f-d curve 100 of the baseline beam for a first 45-50 mm of deflection, but then the f-d curve 90J includes a higher portion 92J rising above the f-d curve 100 until the adhesive 53J of the beam 50J starts to fracture (see the drop 91J). It is contemplated that if the beam 50J was constructed so that the adhesive 53J would not fracture (one option of doing so is explained later herein), a theoretic f-d curve would follow curve 92J as a smooth continuation of the initial f-d curve 90J extrapolated to a greater/improved deflection stroke.

In the FIG. 11, the force versus deflection curve generated when the beam 50J undergoes a side impact (i.e. a bending impact) against a front center of the beam is: Peak load is 23.1 kN; the M_{MAX}=5.08 kN-m; and the M_{MAX}/kg=1.32 kN-m/kg. This compares to a 100%-all-extruded-aluminum beam with baseline data: Peak load is 21.4 kN; the M_{MAX}=4.71 kN-m; and the M_{MAX}/kg=1.20 kN-m/kg. As apparent from the comparison, all three properties improved for the present invention beam, up to an initial point of adhesive failure.

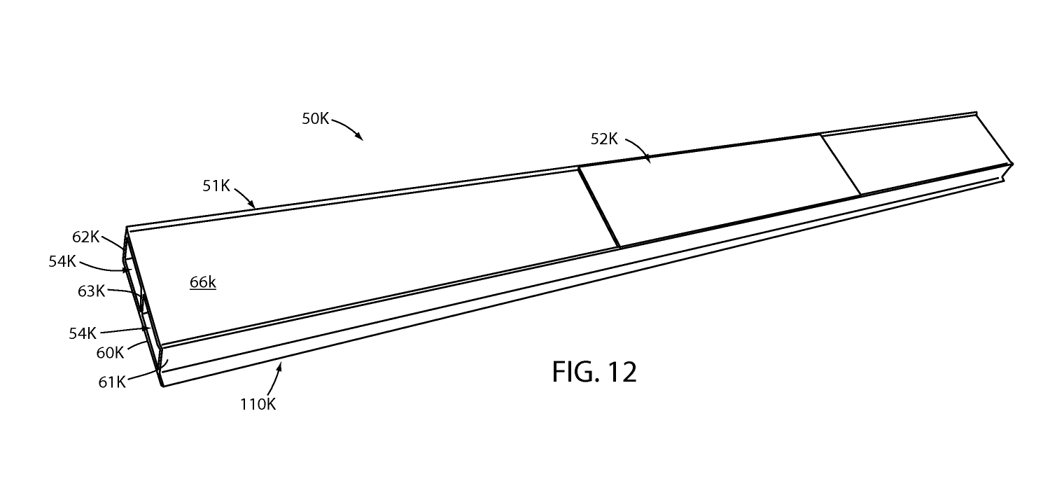

Beam 50K (FIG. 12) is about 1200 mm long and includes an extruded aluminum section 110K defining a closed section of generally about 50 mm-depth and about 110 mm height. Beam 50K is similar to the aluminum beam in FIG. 9A, but includes a short carbon fiber reinforcement patch (CFRP) adhered to its center rear surface (instead of a long patch extending a full length of the beam). The section 110K has aluminum forming front, top, bottom and middle walls 60K-63K, and further includes an aluminum rear wall 66K closing the section to define two closed tubular cavities 54K. A sheet of CFRP 52K of about 400 mm length and 3 mm thickness is adhered centrally to a rear surface of the rear wall 66K.

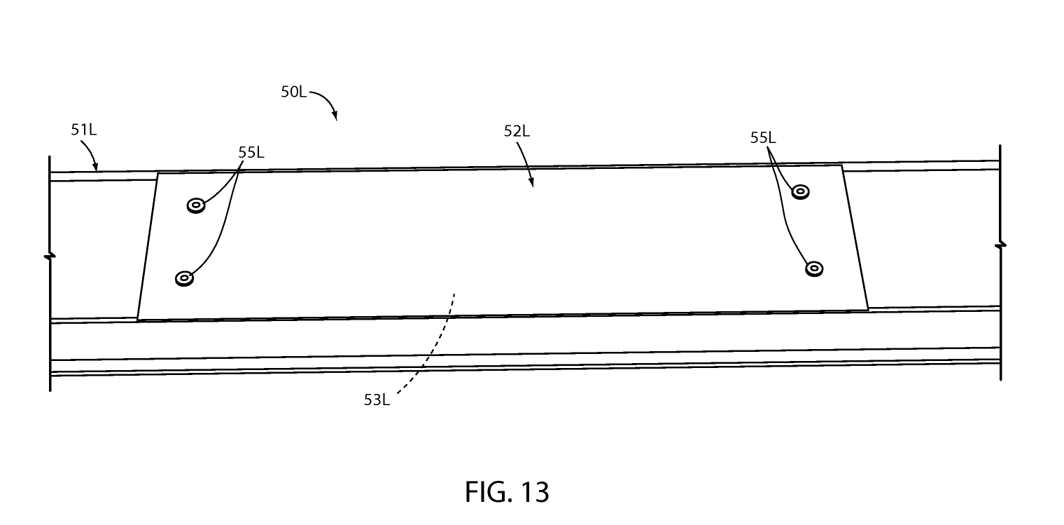

The beam 50K was tested to develop a curve similar to that shown in FIG. 11 and resulted in a similar force-deflection curve with the following data: Peak load is 22.5 kN; the M_{MAX}=4.73 kN-m; and the M_{MAX}/kg=1.14 kN-m/kg. The data from a baseline beam having the same extruded aluminum section (but not having any adhered CFRP section) compares as follows: Peak load is 21.4 kN; the M_{MAX}=4.71 kN-m; and the M_{MAX}/kg=1.20 kN-m/kg. As apparent from the comparison, all three properties improved for the present invention beam 50K over the prior art baseline all-aluminum beam (see line 100 in FIG. 13).

Our testing showed that beam 50K (i.e. an aluminum extrusion forming a closed section, and including a patch of CFRP adhered partially along its rear wall) provides a very surprising and unexpected result in terms of strength and performance, even with a weight reduction. Specifically, using computer aided design analysis, we compared a beam 50K (closed aluminum section with CFRP adhered along rear wall) to a similar all-aluminum beam (i.e. similar shape and size, but no CFRP). Our testing showed that beam 50K could be made 2 kg lighter in weight yet provide an identical bending strength and performance to the all-aluminum beam. Specifically, a weight of the 50K beam was calculated to be 5.7 kg, while a weight of the all-aluminum beam was 7.7 kg, where both provided equivalent performance. This weight savings of 2 kg in view of identical performance is very surprising and unexpected to us.

Beam 50L (FIG. 13) is similar to beam 50K in that beam 50L includes an adhered sheet 52L, but in beam 50L, mechanical fasteners (rivets 55L) were used at both ends of the polymeric sheet section 52L (at top and bottom corners of the patch) to more securely hold the adhered sheet section 52L in position. It is noted that the rivets both hold the sheet section 52L tightly against the extruded aluminum section 51L while the adhesive 53L is curing (thus improving the adhesive bond), but also hold the sections 52L and 51L together in combination with the cured adhesive 53L to provide a stronger connection. Thus, the mechanical fasteners provide a process improvement but also can provide a strength improvement by reducing a tendency of the adhesive 53L to fracture.

The beam 50L was tested to develop a curve similar to that shown in FIG. 11 and resulted in a similar force-deflection curve with the following data: Peak load is 26.96 kN; the M_{MAX}=5.93 kN-m; and the M_{MAX}/kg=1.42 kN-m/kg. This compares to baseline data 100 where: Peak load is 21.4 kN; the M_{MAX}=4.71 kN-m; and the M_{MAX}/kg=1.20 kN-m/kg. As apparent from the comparison, all three properties improved for the present inventive beam.

Thus, it is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A bumper impact beam adapted for impact, comprising:
an extruded aluminum section having a constant cross section;
a long-fiber-reinforced polymeric elongated positioned against a rear side of the aluminum section to define at least one closed cavity; and
adhesive integrally securing the elongated section to the aluminum section so that when impacted anywhere along a front side of the beam, the aluminum section is primarily compressed and the polymeric elongated section is primarily tensioned.

2. The beam in claim 1, wherein the long-fiber-reinforced elongated section includes continuous fibers extending a length of the elongated section.

3. The beam in claim 1, wherein the long-fiber-reinforced elongated section includes carbon fibers.

4. The beam in claim 1, wherein the extruded aluminum section has a front wall and rearwardly-extending walls substantially defining at least one rear-facing concavity; and wherein the long-fiber-reinforced polymeric elongated section is attached to rear ends of the rearwardly-extending walls to close the at least one rear-facing concavity.

5. The beam in claim 1, wherein the aluminum section forms a forward portion of the beam, and the polymeric elongated section forms a rearward portion of the beam, with abutting surfaces of the aluminum section and the polymeric elongated section lying along the beams neutral axis, the neutral axis being defined by a type of stress during an impact directed against the front side of the beam, with the type of stress being primarily compressive stress in the extruded aluminum section and primarily tensile stress in the polymeric elongated section and primarily minimal bending stress along the neutral axis.

6. The beam in claim 1, wherein a location of the adhesive defines a neutral plane of bending moment extending a length of the beam, so that when an impact is directed against the front side of the beam, the adhesive undergoes minimal compressive and tensile stress.

7. The beam in claim 1, wherein the at least one closed cavity includes at least two closed cavities.

8. The beam in claim 1, wherein the extruded aluminum section includes at least one rearwardly-extending wall with an enlarged rearward tip defining one of a channel or transverse foot flange.

9. The beam in claim 1, wherein the extruded aluminum section includes three rearwardly-extending parallel walls.

10. The beam in claim 1, including mechanical fasteners attaching ends of the polymeric elongated section to the extruded aluminum section.

11. A beam adapted for impact, comprising:
an extruded section including parallel walls defining at least one rear concavity, at least one of the walls including a rearwardly-facing tip;
a continuous-fiber-reinforced polymeric elongated section with forwardly-facing walls that abut the parallel walls to close the at least one rear concavity; and
at least one of adhesive and a fastener securing the polymeric elongated section to the extruded section including at the rearwardly-facing tip.

12. The beam in claim 11, wherein the at least one fastener includes adhesive.

13. The beam in claim 12, wherein the at least one fastener includes at least one mechanical fastener near each end of the polymeric elongated section.

14. The beam in claim 11, wherein the rearwardly-facing tip includes a rearwardly-open channel that receives an edge of the forwardly-facing walls.

15. The beam in claim 11, including adhesive in the channel.

16. The beam in claim 11, wherein the rearwardly-facing tip includes a transverse foot flange.

17. The beam in claim 11, wherein the continuous-fiber-reinforced polymeric elongated section includes carbon fiber.

18. A bumper impact beam adapted for impact, comprising:
an extruded aluminum section with a rearwardly-extending wall having a rear tip defining a longitudinal channel; and
a long-fiber-reinforced polymeric elongated section including a forwardly-extending wall having a front tip extending into the longitudinal channel and fixed thereto.

19. The beam in claim 18, including adhesive securing the front and rear tips together.

20. A bumper impact beam adapted for impact, comprising:
an extruded aluminum section including walls defining at least one tubular concavity; and
a long-fiber-reinforced polymeric elongated sheet bonded along its length to a rear one of the walls along at least a center portion of the aluminum section.

21. The beam in claim 20, including a fastener including at least one of adhesive and mechanical fasteners securing the elongated sheet to the aluminum section so that when impacted from a front side, the polymeric elongated section is primarily tensioned and stabilizes a rear one of the walls.

22. The beam in claim 20, wherein the elongated sheet extends less than 75% of a length of the aluminum section.

23. The beam in claim 20, wherein the rear one wall is thinner than the front one of the walls.

24. A method of constructing a vehicle bumper beam comprising:
extruding an aluminum section;
forming a long-fiber-reinforced elongated polymeric section; and
securing the polymeric section to the aluminum section to form at least one closed cavity; the step of securing including applying and curing adhesive.

25. The method of claim 24, wherein the long-fiber-reinforced elongated polymeric section includes continuous reinforcing fibers extending a length of the polymeric section.

26. The method of claim 24, wherein the long-fiber-reinforced polymeric elongated sheet includes carbon fibers.

27. A method of forming a bumper impact beam adapted for impact, comprising:
providing an extruded aluminum section including walls defining at least one tubular concavity; and
adhering a long-fiber-reinforced polymeric elongated sheet to a rear one of the walls along at least a center portion of the aluminum section.
